(19) United States
(12) Patent Application Publication
(10) Pub. No.: US 2021/0350743 A1
(43) Pub. Date: Nov. 11, 2021

(54) METHOD OF USING A DYNAMIC LIGHT FIELD SYSTEM

(71) Applicant: AMERICAN FUTURE TECHNOLOGY, City of Industry, CA (US)

(72) Inventor: You-Chi LIU, City of Industry, CA (US)

(21) Appl. No.: 17/383,894

(22) Filed: Jul. 23, 2021

Related U.S. Application Data
(63) Continuation-in-part of application No. 17/091,771, filed on Nov. 6, 2020.

(30) Foreign Application Priority Data
Dec. 4, 2019 (TW) 108144372

(51) Int. Cl. G09G 3/32; G06T 7/90

(52) U.S. Cl. CPC G09G 3/32; G06T 7/90; G09G 2320/0666; G06T 2207/10024; G09G 2310/08

(57) ABSTRACT

In a method of using dynamic light field, a processing module of a controller compares color pixels of picture files with a preset international color code table, to analyze and obtain international color codes corresponding to the color pixels, and a timing unit of the processing module adds a timing signal for transmission in blocks of the picture files, a transmission module transmits the international color codes and the timing signal to a transmission unit of a light-emitting device, and after receiving the international color codes and the timing signal, the transmission unit of the light-emitting device transmits the international color codes and the timing signal to a processing unit which drives display pixels to play the picture files based on the timing signal and display the corresponding colors. Therefore, the light-emitting device can form a dynamic light field according to the picture files.

This application is a Continuation-In-Part of application Ser. No. 17/091,771, filed on Nov. 6, 2020, for which priority is claimed under 35 U.S.C. § 120, the entire contents of which are hereby incorporated by reference.

This application claims the priority benefit of Taiwan patent application number 108144372, filed on Dec. 4, 2019.

### BACKGROUND OF THE INVENTION

### 1. Field of the Invention

The present invention provides a method of using a dynamic light field system, and more particularly to a method of using a controller to perform color analysis operation on single picture file and drive at least one light emitting device to outwardly project light based on a color analysis result, so as to create effect of dynamic light field.

### 2. Description of the Related Art

Today's lighting system is getting more and more advanced. LED lighting has the advantages of adjustable dimming function, low power consumption, small size, being not easy to break or damage, and long service life. Therefore, LED lighting systems will continue to spread. As the current lighting system is advanced, flexible and more integrated, the light system in many fields (such as: game industry, retail industry, hotel industry or home field, etc.) will enhance the experience through the lighting system, thereby improving productivity, safety, efficiency and leisure.

Furthermore, in order to enhance the lighting experience, some manufacturers use programs to control the LED lighting system to change the color and lighting time of the LEDs, and then create a light field, for example, to create scenes such as torches or the sea. However, the conventional light field setting needs to be written in the program in advance by the manufacturer, and then provided to the user to choose to use, so the user's choice will be limited to the scenes in the program. For users, it is very unattractive, and the light field cannot be adjusted according to their own preferences, resulting in loss of willingness to buy.

### SUMMARY OF THE INVENTION

An objective of the present invention is to provide a method of using a dynamic light field system, and the method includes steps of: using a processing module of the controller to compare color pixels of a plurality of picture files with the preset international color code table, to analyze and obtain international color codes corresponding to the color pixels; using a timing unit of the processing module to add a timing signal for transmission in blocks of the plurality of picture files; using a transmission module to transmit the international color codes and the timing signal to a transmission unit of at least one light emitting device; after the transmission unit of the light emitting device receives the international color codes and the timing signal, transmitting the international color codes and the timing signal to a processing unit, and using the processing unit to drive a plurality of display pixels to play the plurality of picture files based on the timing signal and display the corresponding colors. Therefore, the light emitting device can form and create dynamic light field according to the plurality of picture files, so as to improve diversity in use, reduce difficulty in manufacturing dynamic light field, and achieve the purpose of improving the convenience in overall manufacturing and use.

Another objective of the present invention is that the timing unit of the processing module can be controlled to change timing by an electronic device, so as to adjust light display times of the plurality of display pixels, thereby improving variability in use and achieving the effect of increasing market competitiveness.

### BRIEF DESCRIPTION OF THE DRAWINGS

The structure, operating principle and effects of the present invention will be described in detail by way of various embodiments which are illustrated in the accompanying drawings.

FIG. 1 is a block diagram of a dynamic light field system, in accordance with the present invention.

FIG. 2 is a perspective view of a light emitting device, in accordance with the present invention.

FIG. 3 is a first flowchart of a method of using dynamic light field, in accordance with the present invention.

FIG. 4 is a second flowchart of a method of using dynamic light field, in accordance with the present invention.

FIG. 5 is a schematic view of a picture file, in accordance with the present invention.

FIG. 6 is a front view of a light emitting device before use, in accordance with the present invention.

FIG. 7 is a first schematic view of a light emitting device in use, in accordance with the present invention.

FIG. 8 is a second schematic view of a light emitting device in use, in accordance with the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

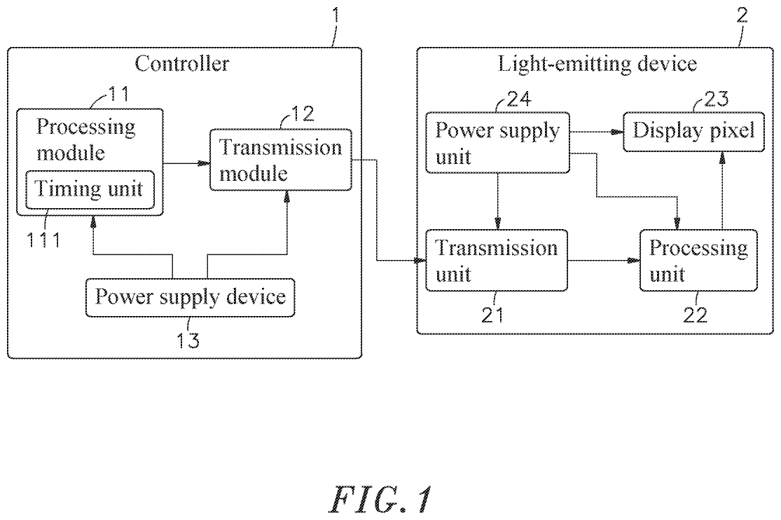

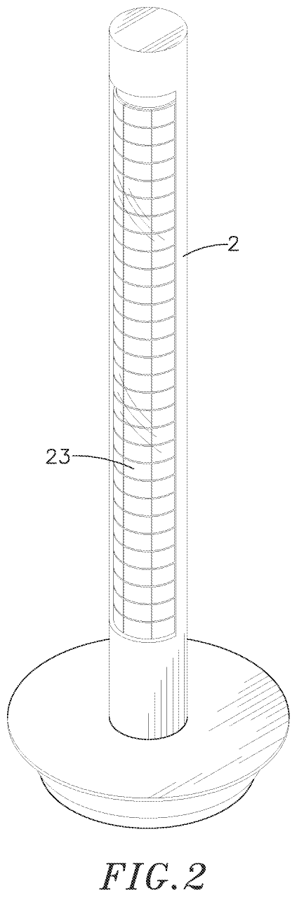

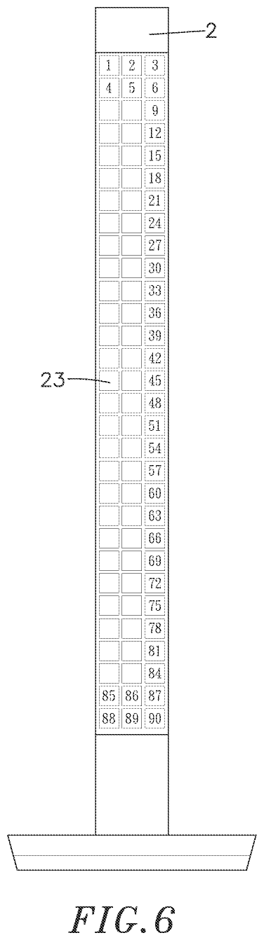

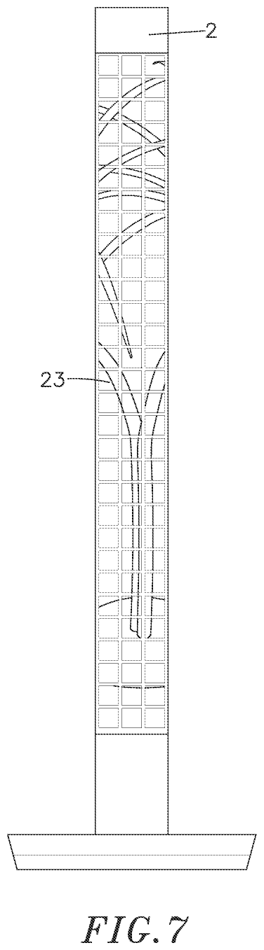

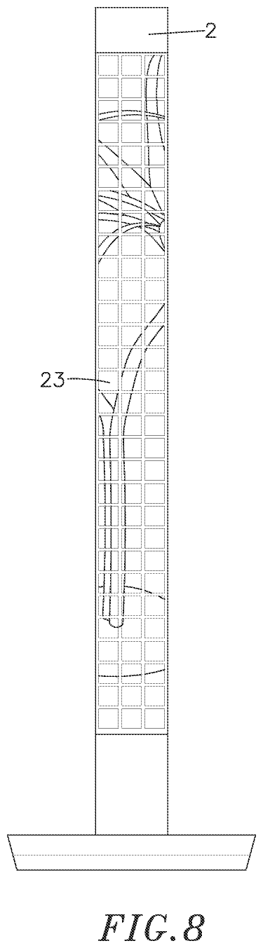

Please refer to FIGS. 1 to 8. As shown in FIG. 1, a dynamic light field system of the present invention includes a controller 1 and at least one light-emitting device 2.

The controller 1 includes a processing module 11, a transmission module 12 and a power supply device 13. The processing module 11 includes a timing unit 111, the processing module 11 is electrically connected to the transmission module 12 and the power supply device 13, and the power supply device 13 is configured to supply power for operation of the controller 1.

The light-emitting device 2 includes a transmission unit 21 configured to receive signals transmitted from the transmission module 12, the transmission unit 21 is electrically connected to a processing unit 22, the processing unit 22 is electrically connected to a plurality of display pixels 23 which are arranged in an array and configured to outwardly project different colors of lights; the display pixel 23 can be a light-emitting diode. The light-emitting device 2 includes a power supply unit 24 configured to supply power to the light-emitting device 2 for operation.

Each of the transmission module 12 of the controller 1 and the transmission unit 21 of each light-emitting device 2 can be a wired transmission interface or a wireless transmission interface for mutual signal transmission. The wired transmission interface can be a wired connection interface such as USB (universal serial bus), micro-USB, mini-USB, USB Type-C, or Lightning. The wireless transmission interface can be a short-range communication device, such as Bluetooth module or Wi-Fi module.

Furthermore, each of the power supply device 13 of the controller 1 and the power supply unit 24 of the light-emitting device 2 can be electrically connected to an external power source using a power transmission line (not shown in figures); for example, the power transmission line can be a power plug. The external power source can be a city power socket or a generator power socket that provides the power required by the controller 1 and the light-emitting device 2; in practical applications, each of the controller 1 and the light-emitting device 2 can also be connected to an external portable power storage device (such as a portable charger) through a USB power transmission line. However, there are many ways and structures for the controller 1 and the light-emitting device 2 to obtain electric power, these ways and structures only needs to provide electric energy to the controller 1 and the light-emitting device 2, and the detailed composition of the structure is not the main point of the present invention and will not be repeated herein.

The above-mentioned light-emitting devices 2 can be devices capable of projecting light outwardly, such as lamp posts, ceiling lamps, or decorative lamps set on the edge of a chair cushion.

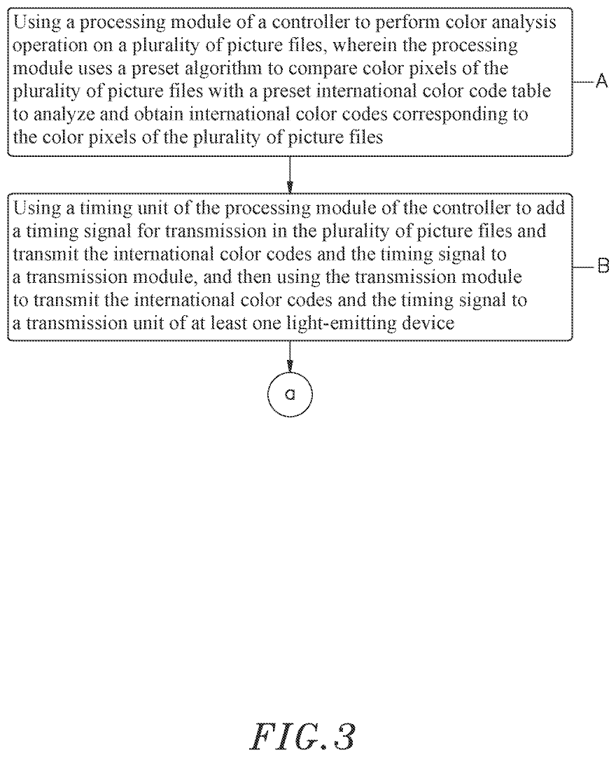

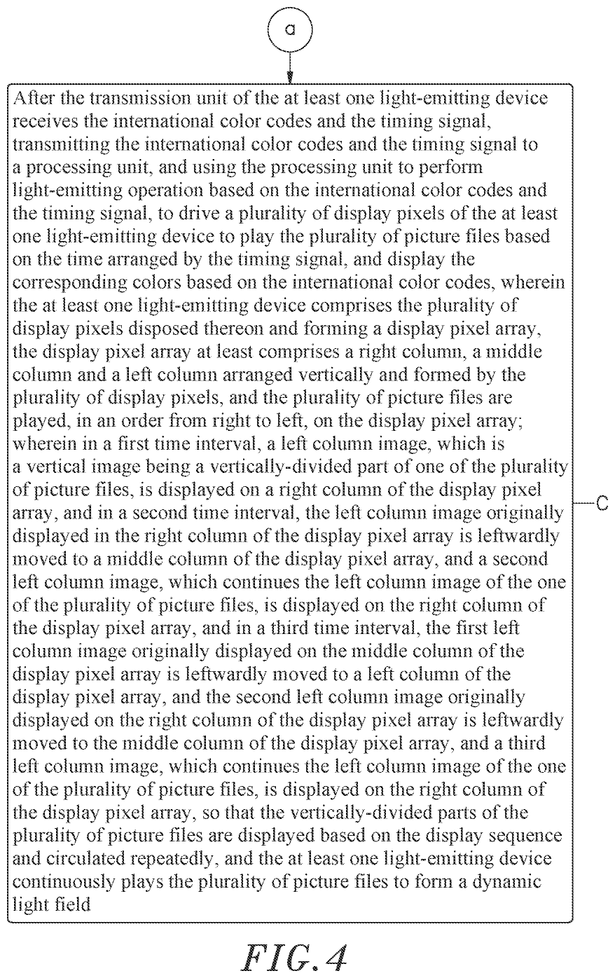

Please refer to FIGS. 3 and 4. The practical operation of the method of using the dynamic light field system of the present invention includes the following steps (A) to (C). In a step (A), the processing module 11 of the controller 1 can perform color analysis operation on each of the picture files 3, the processing module 11 uses a preset algorithm to compare the color pixels (RGB values) of the picture file 3 with the preset international color code table (not shown in figures), so as to analyze and obtain the plurality of international color codes corresponding to the color pixels of each picture file 3.

In a step (B), the processing module 11 of the controller 1 uses the timing unit 111 to add a timing signal for transmission in the picture files 3, and transmits the international color codes and the timing signal to the transmission module 12, and the transmission module 12 transmits the international color codes and the timing signal to the transmission unit 21 of at least one light-emitting device 2.

In a step (C), after the transmission unit 21 of the light-emitting device 2 receives the international color codes and the timing signal, the transmission unit 21 transmits the international color codes and the timing signal to the processing unit 22, and the processing unit 22 performs light-emitting operation based on the international color codes and the timing signal, to drive the display pixels 23 of the light-emitting device 2 to play the picture files 3 based on the time arranged by the timing signal and display the colors corresponding to the international color codes, so that the at least one light-emitting device 2 can display a dynamic light field according to the picture files 3.

In the step (A), the picture files 3 can be transmitted to the processing module 11 of the controller 1 through an electronic device such as a desktop computer, a notebook computer or a tablet computer; the electronic device can be installed with a preset application or a mobile application program (App). Through the application or the mobile application program, a user can select the picture file 3 to be transmitted, and adjust the interval timing between the plurality of picture files 3 in the step (B), so as to change the light display times of the display pixels 23. For example, the interval timing is greater than zero second.

Furthermore, when the dynamic light field is displayed, the at least one light-emitting device 2 can display a group of picture files 3 individually, and be in cooperation with another light-emitting device 2, so as to display and create the dynamic light field. However, in an actual application, the light-emitting devices 2 can collectively display a group of picture files 3, that is, the light-emitting device 2 can be used to continuously play the picture files 3, so as to continuously play and display the picture files 3 to create the dynamic light field.

In this embodiment, the picture files 3 for displaying swinging grass are taken as examples for exemplary illustration of practical use of the present invention. The processing module 11 of the controller 1 can perform color analysis operation on the picture files 3 storing swinging grass pictures, the processing module 11 compares the preset international color code table with the color pixels of the picture files 3 storing the swinging grass pictures, to analyze and obtain the international color codes corresponding to the color pixels of the picture files 3 storing the swinging grass pictures. The processing module 11 of the controller 1 can add the timing signal in the picture files 3 storing the swinging grass pictures, and transmit the picture files 3 to the processing unit 22 through the transmission module 12, the processing unit 22 can drive the display pixels 23 based on the international color codes and the timing signal, so as to display the picture files 3 on the display pixels 23 of the at least one light-emitting device 2 based on the time arranged by the timing signal and display the colors corresponding to the picture files 3 of grass pictures based on the international color codes. As a result, the picture files 3 of different grass pictures can be continuously played by the at least one light-emitting device 2, to display and create the dynamic light field of swinging grass.

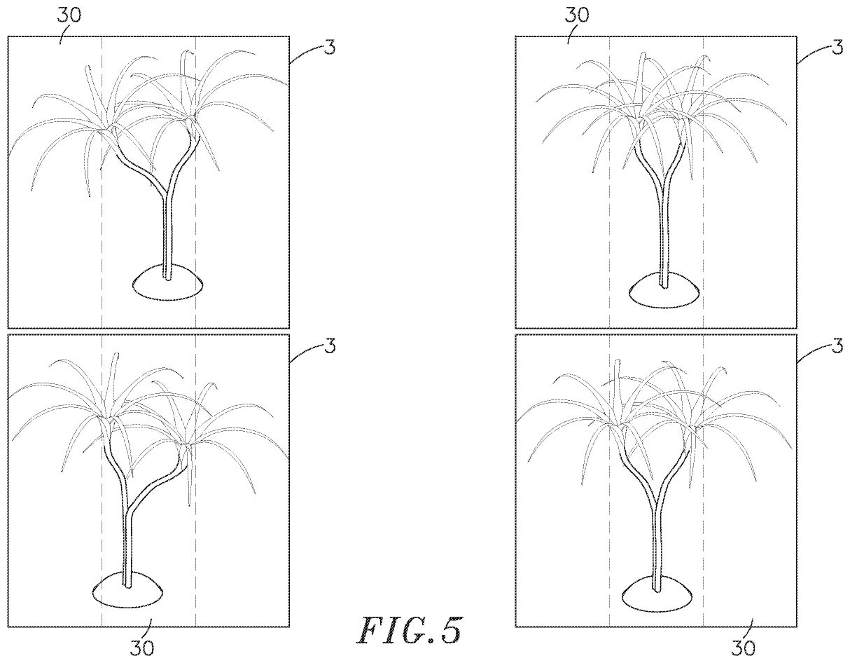

Please refer to FIGS. 5 to 8, which show an embodiment of playing multiple scenario pictures based on the international color codes and the timing signal. According to content disclosed in the step (C), the at least one light-emitting device 2 of the present invention includes display pixels 23 disposed thereon and forming a display pixel array of 3×30, the display pixel array at least comprises a right column, a middle column and a left column arranged vertically and formed by the display pixels; however, the amount of the display pixel array of the present invention is not limited to aforementioned example, and the display pixel array can have different rows and columns. The display pixels 23 of the display pixel array are assigned numbers from 1 to 90 in an order from top left to bottom right, respectively, and the display pixel array can be used to play the picture files 3 in an order from right to left. In a first time interval, the pixels (assigned to numbers 3 to 90) of the right column of the display pixel array display a left column image of the picture file 3 of grass picture; the left column image is a vertically-divided part of the picture file 3. In a second time interval, the left column image of the picture file 3 of grass picture is leftwardly moved to the pixels (assigned to numbers 2 to 89) of a middle column of the display pixel array, and a second left column image continuing the left column image of the picture file 3 of grass picture is displayed on the pixels of the right column of the display pixel array. In a third time interval, the left column image of the picture file 3 originally displayed on the middle column of the display pixel array is leftwardly moved to the pixels (assigned to numbers 1 to 88) of the left column of the display pixel array, and the second left column image of the picture file 3 is leftwardly moved to the middle column of the display pixel array, and a third left column image continuing the second left column image of the picture file 3 of grass picture is displayed on the right column of the display pixel array. The above-mentioned display sequence can be circulated repeatedly, so that the picture files 3 of different grass pictures can be played continuously through the at least one light-emitting device 2, to create the dynamic light field of swinging grass.

The persons skilled in the art can use single picture file 3 of grass picture as an image source and use the processing module 11 to perform the color analysis operation and compare the color pixels of the single picture file 3 storing swinging grass picture with the preset international color code table to analyze and obtain the international color codes corresponding to the color pixels of the picture file 3 storing swinging grass picture; the processing module 11 of the controller 1 can add the timing signal in the single picture file 3 of grass picture, and the transmission module 12 can transmit the picture file 3 to the processing unit 22, the processing unit 22 can drive the display pixels 23 to play the single picture file 3 of grass picture in a horizontal direction based on the international color codes and the timing signal. The above-mentioned modifications and variations can be made thereto by those skilled in the art without departing from the spirit and scope of the disclosure set forth in the claims.

Please refer to FIGS. 5 to 8. the practical implementation of playing the single picture file 3 of grass picture to create the dynamic light field can also include the following steps (X) to (Z).

In a step (X), the processing module 11 of the controller 1 can perform color analysis operation, and the processing module 11 can use the preset algorithm to compare the color pixels (RGB values) of the picture file 3 with the international color code table, to analyze and obtain the international color codes corresponding to the color pixels of the picture file 3, and the processing module 11 can vertically divide the single picture file 3 into a plurality of blocks 30, as shown in FIG. 5.

In a step (Y), the processing module 11 of the controller 1 can use the timing unit 111 to add the timing signal for transmission in the plurality of blocks 30 of the single picture file 3, and transmit the international color codes and the timing signal to the transmission module 12; the transmission module 12 then transmits the international color codes and the timing signal to the transmission unit 21 of the at least one light-emitting device 2.

In a step (Z), after the transmission unit 21 of the light-emitting device 2 receives the international color codes and the timing signal, the transmission unit 21 transmits the international color codes and the timing signal to the processing unit 22, and the processing unit 22 then performs light-emitting operation based on the international color codes and the timing signal to drive the plurality of display pixels 23, so that the display pixels 23 of the light-emitting device 2 are driven to continuously display the blocks 30 of the single picture file 3 based on the time arranged by the timing signal, thereby displaying the corresponding color based on the international color codes. As a result, the plurality of light-emitting devices 2 can display and create the dynamic light field based on the single picture file 3.

In an embodiment, in the step (X), the processing module 11 of the controller 1 can divide the single picture file 3 into two, three, four, five or more blocks 30, and preferably each block 30 includes a plurality of international color codes; however, in an actual application, the block 30 can include only one international color code.

Using the single picture file 3 of grass picture is taken as an example for exemplary illustration of an embodiment, in practical use of the present invention, the processing module 11 of the controller 1 can perform color analysis operation on the single picture file 3 of grass picture, the processing module 11 then compares the international color code table with the color pixels of the single picture file 3 of grass picture, to analyze and obtain the international color codes corresponding to the color pixels of the picture file 3 storing the swinging grass picture, and the processing module 11 then divides the single picture file 3 into the plurality of blocks 30 and adds the timing signal into the plurality of blocks 30, and the transmission module 12 transmits the blocks 30 to the transmission unit 21 of the at least one light-emitting device 2. After the transmission unit 21 of the light-emitting device 2 receives the international color codes and the timing signal, the transmission unit 21 transmits the international color codes and the timing signal to the processing unit 22, and the processing unit 22 can drive the display pixels 23 based on the international color codes and the timing signal, so that the display pixels 23 of the at least one light-emitting device 2 can be driven to continuously display the blocks 30 of the single picture file 3 based on the time arranged by the timing signal, to display the colors corresponding to the picture file 3 of grass picture based on the international color codes. As a result, the plurality of light-emitting devices 2 can create and display the dynamic light field of the swinging grass.

FIGS. 5 to 7 shows the embodiment of playing the single scenario picture or multiple scenario pictures based on the international color codes and the timing signal, and the manner of displaying single scenario picture and the manner of displaying multiple scenario pictures are much the same, and these two variations can be made thereto by those skilled in the art without departing from the spirit and scope of the disclosure set forth in the claims.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A method of using a dynamic light field system, comprising:
(A): using a processing module of a controller to perform color analysis operation on a plurality of picture files, wherein the processing module uses a preset algorithm to compare color pixels of the plurality of picture files with a preset international color code table to analyze and obtain international color codes corresponding to the color pixels of the plurality of picture files;
(B): using a timing unit of the processing module of the controller to add a timing signal for transmission in the plurality of picture files and transmit the international color codes and the timing signal to a transmission module, and then using the transmission module to transmit the international color codes and the timing signal to a transmission unit of at least one light-emitting device; and
(C): after the transmission unit of the at least one light-emitting device receives the international color codes and the timing signal, transmitting the international color codes and the timing signal to a processing unit, and using the processing unit to perform light-emitting operation based on the international color codes and the timing signal, to drive a plurality of display pixels of the at least one light-emitting device to play the plurality of picture files based on the time arranged by the timing signal, and display the corresponding colors based on the international color codes, wherein the at least one light-emitting device comprises the plurality of display pixels disposed thereon and forming a display pixel array, the display pixel array at least comprises a right column, a middle column and a left column arranged vertically and formed by the plurality of display pixels, and the plurality of picture files are played, in an order from right to left, on the display pixel array; wherein in a first time interval, a left column image, which is a vertically-divided part of one of the plurality of picture files, is displayed on a right column of the display pixel array, and in a second time interval, the left column image originally displayed in the right column of the display pixel array is leftwardly moved to a middle column of the display pixel array, and a second left column image, which continues the left column image of the one of the plurality of picture files, is displayed on the right column of the display pixel array, and in a third time interval, the first left column image originally displayed on the middle column of the display pixel array is leftwardly moved to a left column of the display pixel array, and the second left column image originally displayed on the right column of the display pixel array is leftwardly moved to the middle column of the display pixel array, and a third left column image, which continues the left column image of the one of the plurality of picture files, is displayed on the right column of the display pixel array, so that the vertically-divided parts of the plurality of picture files are displayed based on the display sequence and circulated repeatedly, and the at least one light-emitting device continuously plays the plurality of picture files to form a dynamic light field.

2. The method of using a dynamic light field system according to claim 1, wherein in the step (A), the plurality of picture files are transmitted to the processing module of the controller through an electronic device, and the electronic device is installed with an application program or a mobile application program, the application program or the mobile application program is used to select the plurality of picture files to be transmitted, and adjust an interval timing between the plurality of picture files to change light display times of the plurality of display pixels in the step (B), and the interval timing is greater than zero second.
